(19) United States
(12) Patent Application Publication
(10) Pub. No.: US 2014/0253276 A1
(43) Pub. Date: Sep. 11, 2014

(54) LAMINATED INDUCTOR

(71) Applicant: MURATA MANUFACTURING CO., LTD., Kyoto (JP)

(72) Inventors: Keisuke IWASAKI, Nagaokakyo-shi (JP); Norimichi ONOZAKI, Nagaokakyo-shi (JP); Hiroki HASHIMOTO, Nagaokakyo-shi (JP)

(73) Assignee: MURATA MANUFACTURING CO., LTD., Kyoto (JP)

(21) Appl. No.: 14/174,680

(22) Filed: Feb. 6, 2014

(30) Foreign Application Priority Data
Mar. 6, 2013 (JP) 2013-044220

(51) Int. Cl. H01F 27/28

(52) U.S. Cl. CPC H01F 27/2804
USPC 336/200

(57) ABSTRACT

A laminated inductor having a laminate formed by laminating a plurality of insulator layers. A plurality of inductive conductor layers are provided in the laminate and connected in parallel. In a cross section perpendicular to a direction in which a current passes through the inductive conductor layers, a combined cross-sectional shape of the inductive conductor layers constitutes an ellipse as a whole.

### CROSS REFERENCE TO RELATED APPLICATIONS

This application claims benefit of priority to Japanese Patent Application No. 2013-044220 filed on Mar. 6, 2013, the entire content of which is incorporated herein by reference.

### TECHNICAL FIELD

1. Field of the Invention

The present disclosure relates to a laminated inductor including a laminate with an inductor provided therein.

2. Background

As a conventional laminated inductor, an electronic component disclosed in, for example, Japanese Patent Laid-Open Publication No. 2009-170446 is known. The electronic component disclosed in Japanese Patent Laid-Open Publication No. 2009-170446 will be described below. FIG. 9 is an external oblique view of the electronic component 500 disclosed in Japanese Patent Laid-Open Publication No. 2009-170446. FIG. 10 is an exploded oblique view of the electronic component 500 disclosed in Japanese Patent Laid-Open Publication No. 2009-170446. FIG. 11 is a diagram illustrating a cross section taken along line B-B of FIG. 9, along with magnetic field lines H500 created by internal electrodes 508a to 508e.

The electronic component 500 includes a laminate 512, external electrodes 514a and 514b, the internal electrodes 508a to 508e, and via-conductors 500Ba to 500Bd, and has a rectangular solid shape as shown in FIG. 9.

The laminate 512 is formed by laminating non-magnetic layers 504a to 504e and magnetic layers 505a to 505f, as shown in FIG. 10. The internal electrodes 508a to 508e are provided on principal surfaces of the magnetic layers 504a to 504e. Moreover, the internal electrodes 508a to 508e are led out at opposite ends to side surfaces of the laminate 512. In addition, the internal electrodes 508a to 508e are connected to one another by the via-conductors 500Ba to 500Bd, which pierce through the non-magnetic layers 504a to 504d, respectively, in the direction of lamination. The external electrodes 514a and 514b are provided on the side surfaces of the laminate 512 so as to be connected to the internal electrodes 508a to 508e, as shown in FIG. 9.

Since the internal electrodes 508a to 508e of the electronic component 500 thus configured are connected by the via-conductors 500Ba to 500Bd, the internal electrodes 508a to 508e function as a so-called straight electrode. Moreover, the electronic component 500 functions as an inductor.

Incidentally, looking at a cross-sectional structure of the electronic component 500, each of the internal electrodes 508a to 508e has a rectangular cross section, as shown in FIG. 11. In such a case where the cross sections of the internal electrodes 508a to 508e are rectangular, when a current is applied through the internal electrodes 508a to 508e, magnetic fluxes concentrate around the corners of the internal electrodes 508a to 508e, as shown in FIG. 11. Accordingly, magnetic saturation occurs around the corners of the internal electrodes 508a to 508e, resulting in a reduced inductance value of the electronic component 500.

### SUMMARY

A laminated inductor according to an embodiment of the present disclosure includes a laminate formed by laminating a plurality of insulator layers, and a plurality of inductive conductor layers provided in the laminate and connected in parallel. In a cross section perpendicular to a direction in which a current passes through the inductive conductor layers, a combined cross-sectional shape of the inductive conductor layers constitutes an ellipse as a whole.

### BRIEF DESCRIPTION OF THE DRAWINGS

FIG. 1 is an external oblique view of a laminated inductor according to an embodiment;

FIG. 2 is an exploded oblique view of the laminated inductor according to the embodiment;

FIG. 3 is a diagram illustrating a cross section taken along line A-A of FIG. 1, along with magnetic field lines created by inductive conductor layers;

FIG. 4 is a cross-sectional view of laminated inductive conductor layers during production;

FIG. 5 is another cross-sectional view of the laminated inductive conductor layers during production;

FIG. 6 is a cross-sectional view of a laminated coil according to a comparative example;

FIG. 7 is a cross-sectional view of a second sample;

FIG. 8 is a graph showing the results of a first experiment for the first and second samples;

FIG. 9 is an external oblique view of an electronic component disclosed in Japanese Patent Laid-Open Publication No. 2009-170446;

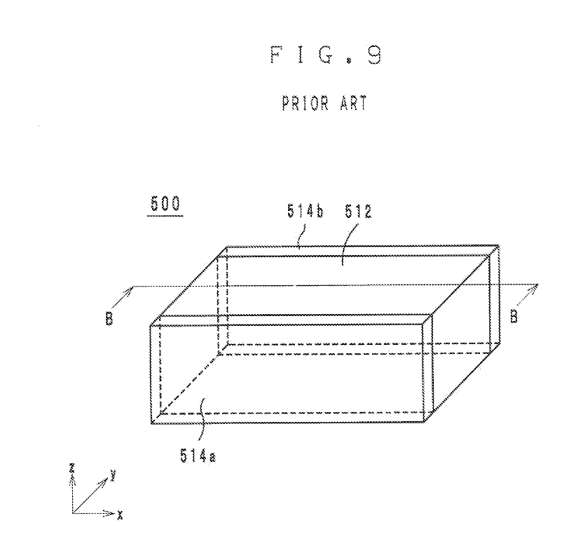

FIG. 10 is an exploded oblique view of the electronic component disclosed in Japanese Patent Laid-Open Publication No. 2009-170446;

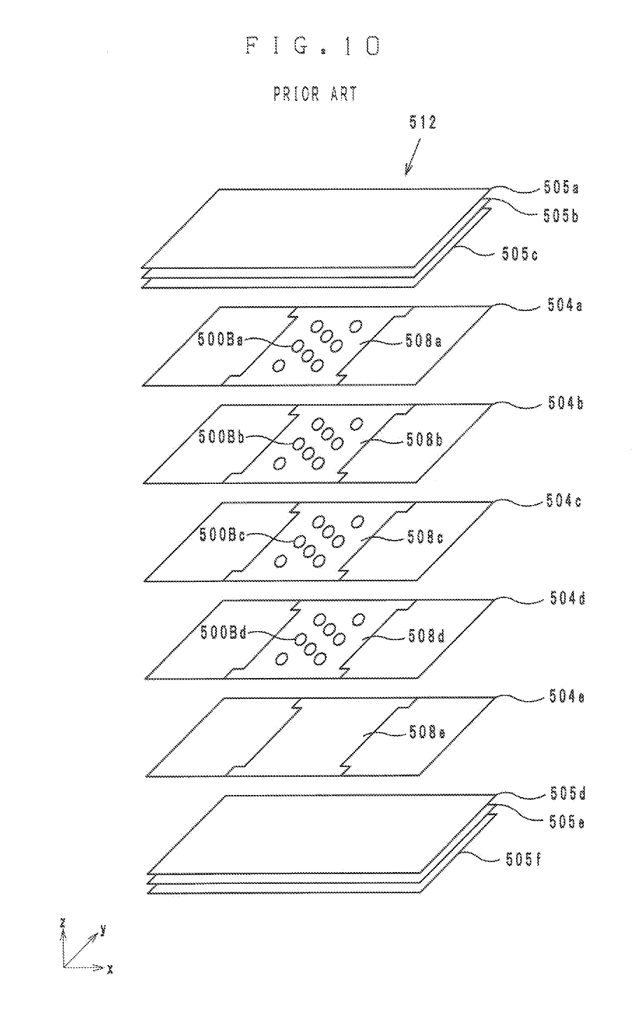

FIG. 11 is a diagram illustrating a cross section taken along line B-B of FIG. 9, along with magnetic field lines created by internal electrodes.

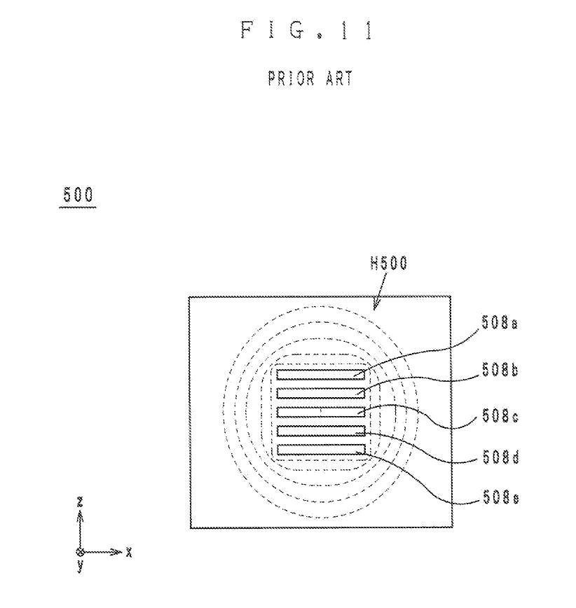

### DETAILED DESCRIPTION

### Configuration of Laminated Inductor

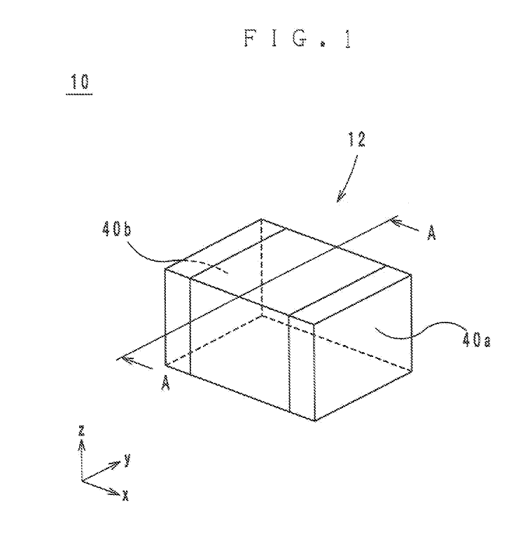

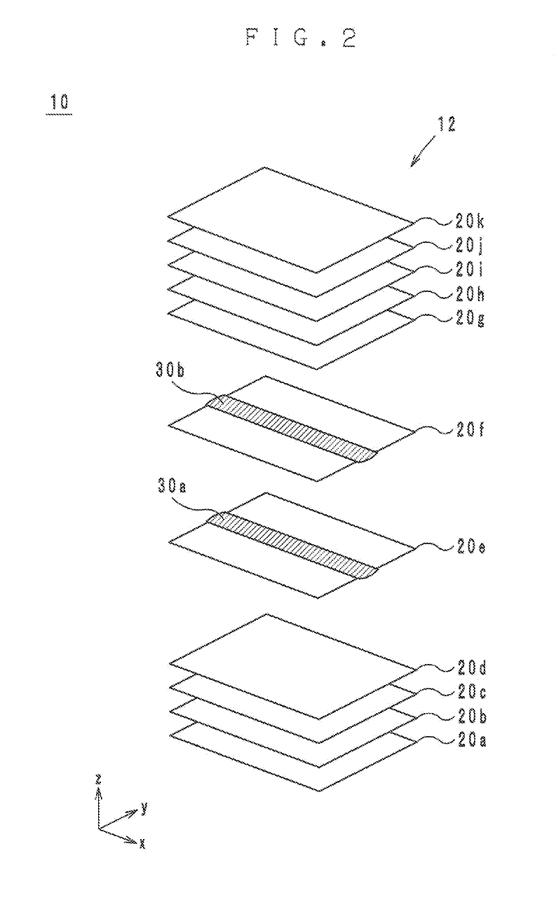

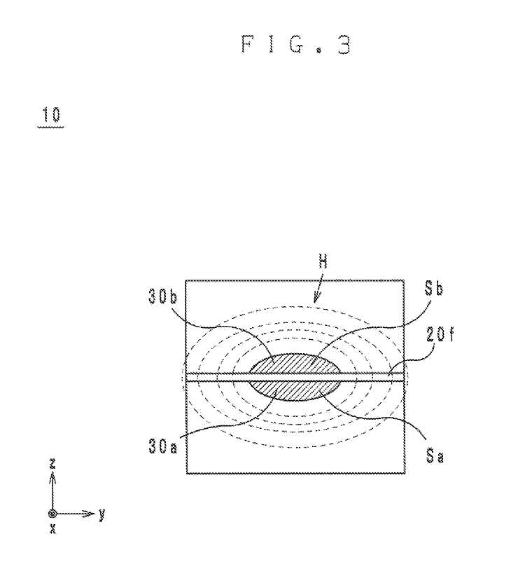

Hereinafter, a laminated inductor 10 according to an embodiment will be described with reference to the drawings. FIG. 1 is an external oblique view of the laminated inductor 10 according to the embodiment. FIG. 2 is an exploded oblique view of the laminated inductor 10 according to the embodiment. FIG. 3 is a diagram illustrating a cross section taken along line A-A of FIG. 1, along with magnetic field lines H created by inductive conductor layers 30a and 30b. In the following, the direction of lamination of the laminated inductor 10 will be defined as a z-axis direction, and the direction along the long side of the laminated inductor 10, when viewed in a plan view in the z-axis direction, will be defined as an x-axis direction. Moreover, the direction along the short side of the laminated inductor 10, when viewed in a plan view in the z-axis direction, will be defined as a y-axis direction. Note that the x-, y-, and z-axes are perpendicular to one another.

The laminated inductor 10 includes a laminate 12, the inductive conductor layers 30a and 30b, and external electrodes 40a and 40b, and has a rectangular solid shape as shown in FIG. 1.

The laminate 12 is formed by laminating insulator layers 20a to 20k in this order, from the negative side to the positive side in the z-axis direction, as shown in FIG. 2. Moreover, each of the insulator layers 20a to 20k is rectangular when viewed in a plan view in the z-axis direction. Accordingly, the laminate 12 formed by laminating the insulator layers 20a to 20k is in the shape of a rectangular solid, as shown in FIG. 1. Note that the insulator layers 20a to 20e and 20g to 20k are made of a magnetic material. The insulator layers 20a to 20e and 20g to 20k are made of, for example, ferrite. The insulator layer 20f (predetermined insulator layer) is made of a non-magnetic material. The insulator layer 20f is made of, for example, borosilicate glass and ceramic filler. Moreover, the insulator layers 20a to 20e and 20g to 20k are 70 μm thick, and the insulator layer 20f is 25 μm thick. In the following, the surfaces of the insulator layers 20a to 20k that are located on the positive side in the z-axis direction will be referred to as top surfaces, and the surfaces of the insulator layers 20a to 20k that are located on the negative side in the z-axis direction will be referred to as bottom surfaces.

The inductive conductor layers 30a and 30b form an inductor inside the laminate 12. Specifically, the inductive conductor layer 30a is positioned on the top surface of the insulator layer 20e, i.e., it is positioned along the bottom surface of the insulator layer 20f across its central portion relative to the y-axis direction, as shown in FIG. 2. Moreover, the inductive conductor layer 30b is positioned on the top surface of the insulator layer 20f so as to extend along its central portion relative to the y-axis direction, as shown in FIG. 2. Accordingly, the insulator layer 20f (predetermined insulator layer) is positioned between the inductive conductor layers 30a and 30b. In addition, the inductive conductor layers 30a and 30b, when viewed in a plan view in the z-axis direction, approximately overlap with each other. Further, each of the inductive conductor layers 30a and 30b is exposed at opposite ends at the surfaces of the laminate 12 that are located on the positive and negative sides, respectively, in the x-axis direction, so as to be connected to the external electrodes 40a and 40b, which will be described later. That is, the inductive conductor layers 30a and 30b are connected in parallel between the external electrodes 40a and 40b. The direction in which current flows through each of the inductive conductor layers 30a and 30b is the x-axis direction.

Furthermore, the inductive conductor layers 30a and 30b are strip-like conductor layers extending straight in the x-axis direction, as shown in FIG. 2. The width of each of the inductive conductor layers 30a and 30b in the y-axis direction is approximately uniform. The cross-sectional shape Sa of the inductive conductor layer 30a in a direction perpendicular to the x-axis direction is a semi-ellipse that bulges toward the negative side in the z-axis direction, as shown in FIG. 3. Moreover, the cross-sectional shape Sb of the inductive conductor layer 30b in the direction perpendicular to the x-axis direction is a semi-ellipse that bulges toward the positive side in the z-axis direction, as shown in FIG. 3. Accordingly, the combination of the cross-sectional shapes Sa and Sb constitutes an ellipse as a whole. Note that the wording “to constitute an ellipse as a whole” is intended to mean that, in the present embodiment, the segment of the cross-sectional shape Sa that is located on the negative side in the z-axis direction (i.e., the part of the cross-sectional shape Sa that is out of contact with the insulator layer 20f) and the segment of the cross-sectional shape Sb that is located on the positive side in the z-axis direction (i.e., the part of the cross-sectional shape Sb that is out of contact with the insulator layer 20f) form an elliptical shape in combination. The inductive conductor layers 30 are made of a conductive material such as Au, Ag, Pd, Cu, or Ni. Moreover, the inductive conductor layers 30a and 30b are 70 μm thick. Accordingly, the insulator layer 20f is thinner than each of the inductive conductor layers 30a and 30b.

The external electrode 40a is provided so as to cover the surface of the laminate 12 that is located on the positive side in the x-axis direction, as shown in FIG. 1. Moreover, the external electrode 40b is provided so as to cover the surface of the laminate 12 that is located on the negative side in the x-axis direction. Note that the external electrodes 40a and 40b are made of a conductive material such as Au, Ag, Pd, Cu, or Ni. In addition, the external electrodes 40a and 40b are connected to both ends of the inductive conductor layers 30a and 30b, as described earlier. As a result, the inductive conductor layers 30a and 30b are connected in parallel between the external electrodes 40a and 40b, thereby constituting a single inductor.

### Method for Producing Laminated Inductor

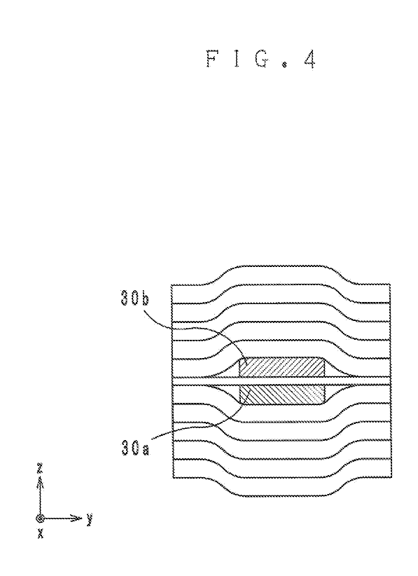

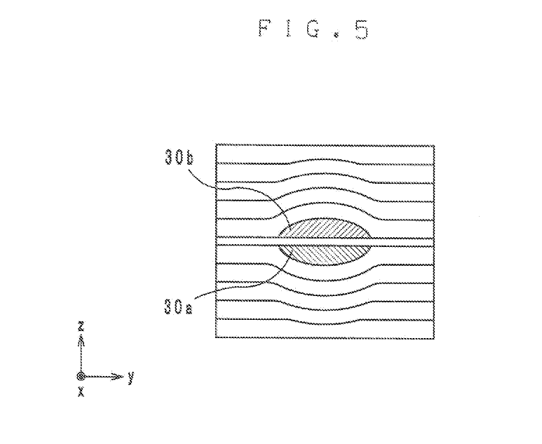

The method for producing the laminated inductor 10 thus configured will be described below. While the following description focuses on one laminated inductor 10, in actuality, a mother laminate for a plurality of unsintered laminates 12 is produced and cut, and thereafter, external electrodes 40a and 40b are formed to obtain a plurality of laminated inductors 10. FIGS. 4 and 5 are cross-sectional views of a laminated inductor 10 during production. Note that the direction of lamination of ceramic green sheets will be defined as a z-axis direction, and the direction along the long side of the produced laminated inductor 10, when viewed in a plan view in the z-axis direction, will be defined as an x-axis direction. In addition, the direction along the short side of the produced laminated inductor 10, when viewed in a plan view in the z-axis direction, will be defined as a y-axis direction. Furthermore, the x-, y-, and z-axes are perpendicular to one another.

Initially, ceramic green sheets from which to make insulator layers 20a to 20e and 20g to 20k are prepared. Specifically, materials weighed at a predetermined ratio, including ferric oxide (Fe2O3), zinc oxide (ZnO), and nickel oxide (NiO), are introduced into a ball mill as raw materials, and subjected to wet mixing. The resultant mixture is dried and ground to obtain powder, which is pre-sintered. Further, the pre-sintered powder is subjected to wet grinding in the ball mill, and thereafter dried and cracked to obtain magnetic powder.

To the obtained magnetic powder, a binder (vinyl acetate, water-soluble acrylic, or the like), a plasticizer, a wetting agent, and a dispersing agent are added and mixed in the ball mill, and thereafter defoamed under reduced pressure. The resultant ceramic slurry is spread over carrier sheets by a doctor blade method and dried to form ceramic green sheets from which to make insulator layers 20a to 20e and 20g to 20k.

Also, in parallel with the preparation of the ceramic green sheets from which to make insulator layers 20a to 20e and 20g to 20k, a ceramic green sheet from which to make an insulator layer 20f is prepared. The process of producing the ceramic green sheet from which to make an insulator layer 20f is basically the same as the process of producing the ceramic green sheets from which to make insulator layers 20a to 20e and 20g to 20k, except that the materials thereof are borosilicate glass and ceramic filler, and therefore, any descriptions thereof will be omitted herein.

Next, a conductive paste mainly composed of, for example, Au, Ag, Pd, Cu, or Ni is applied by screen printing or photolithography onto the ceramic green sheets from which to make insulator layers 20e and 20f, and thereafter, dried to form inductive conductor layers 30a and 30b.

Next, the ceramic green sheets from which to make insulator layers 20a to 20k are laminated in this order and subjected to pressure-bonding, thereby obtaining an unsintered mother laminate. Thereafter, the unsintered mother laminate is firmly bonded under pressure, for example, by isostatic pressing.

Note that after the lamination of the ceramic green sheets, the thickness of the mother laminate in the z-axis direction is greater where the inductive conductor layers 30a and 30b are provided than where they are not provided, as shown in FIG. 4, by the combined thickness of the inductive conductor layers 30a and 30b. Moreover, the inductive conductor layers 30a and 30b are harder than the ceramic green sheets. Accordingly, when the mother laminate in the above state is subjected to pressure treatment, the ceramic green sheets in the mother laminate are compressed significantly where the inductive conductor layers 30a and 30b are provided, as shown in FIG. 5. However, the thickness of the mother laminate in the z-axis direction changes continuously at the boundary between where the inductive conductor layers 30a and 30b are provided and where they are not provided, as shown in FIG. 5. Therefore, the inductive conductor layers 30a and 30b are compressed more greatly at opposite ends in the y-axis direction than at the center in the y-axis direction.

Furthermore, the inductive conductor layers 30a and 30b are opposed to each other with respect to the ceramic green sheet that is to act as the insulator layer 20f, which is thinner than each of the inductive conductor layers 30a and 30b. Here, the extent of the insulator layer 20f being compressed by pressure treatment is determined by the thickness of the insulator layer 20f, and the insulator layer 20f is thinner than each of the inductive conductor layers 30a and 30b. Accordingly, the extent of the insulator layer 20f being compressed is insignificant compared to the thickness of each of the inductive conductor layers 30a and 30b. Therefore, the insulator layer 20f is scarcely compressed by pressure treatment, so that the inductive conductor layer 30a is pushed to the negative side in the z-axis direction, and the inductive conductor layer 30b is pushed to the positive side in the z-axis direction. As a result, the cross section of the inductive conductor layer 30a has a semi-elliptical shape that bulges toward the negative side in the z-axis direction, and the cross section of the inductive conductor layer 30b has a semi-elliptical shape that bulges toward the positive side in the z-axis direction. That is, the combined cross-sectional shape of the inductive conductor layers 30a and 30b constitutes an ellipse as a whole.

Next, the mother laminate is cut by a cutter into a predetermined size, thereby obtaining unsintered laminates 12. Thereafter, each of the unsintered laminates 12 is subjected to debinding and sintering. The debinding is performed, for example, in a low-oxygen atmosphere at 500° C. for two hours. The sintering is performed, for example, at 800° C. to 900° C. for 2.5 hours.

Next, external electrodes 40a and 40b are formed. Initially, an electrode paste, which is made of a conductive material mainly composed of Ag, is applied onto side surfaces of the laminate 12. Then, the applied electrode paste is baked at about 800° C. for one hour. As a result, bases of the external electrodes 40a and 40b are formed.

Lastly, the surfaces of the bases are plated with Ni or Sn. As a result, the external electrodes 40a and 40b are formed. By the foregoing process, the laminated inductor 10 is completed.

### Effects

The laminated inductor 10 renders it possible to inhibit reduction in the inductance value due to magnetic saturation. Specifically, when a current is applied to the inductive conductor layers 30a and 30b, magnetic field lines H are generated along the periphery of the inductive conductor layers 30a and 30b, as shown in FIG. 3. In addition, the combined cross-sectional shape of the inductive conductor layers 30a and 30b constitutes an ellipse as a whole. That is, the combined cross-sectional shape of the inductive conductor layers 30a and 30b has no angles. Accordingly, in the laminated inductor 10, there are no angles around which magnetic fluxes concentrate, so that magnetic saturation can be inhibited. Thus, the laminated inductor 10 renders it possible to inhibit reduction in the inductance value due to magnetic saturation.

Furthermore, in the case of the laminated inductor 10, magnetic fluxes essentially do not concentrate around the corners of the inductive conductor layers 30a and 30b, as described above, and therefore, magnetic field lines circulate around the inductive conductor layers 30a and 30b smoothly. Thus, the laminated inductor 10 is capable of having a large inductance value before a large amount of current flows thereinto, i.e., the so-called initial inductor value of the laminated inductor 10 can be high.

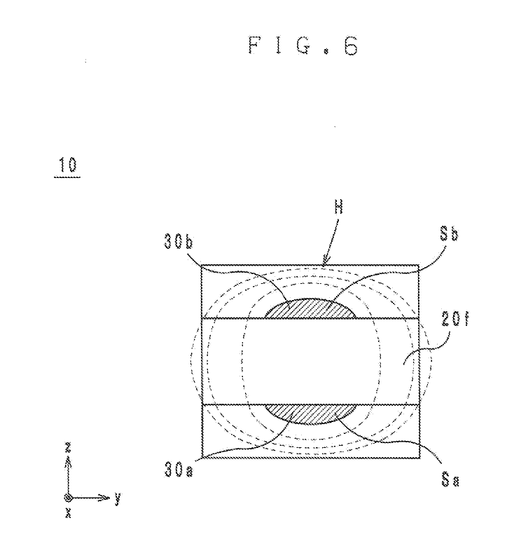

Furthermore, in the laminated inductor 10, the insulator layer 20f is thinner than each of the inductive conductor layers 30a and 30b. Therefore, the laminated inductor 10 renders it possible to inhibit reduction in the inductance value. Specifically, if the insulator layer 20f is thicker than each of the inductive conductor layers 30a and 30b, the distance between the inductive conductor layers 30a and 30b increases. In such a case, the magnetic field lines H circulating within the laminate 12 become dense near both of the end surfaces of the laminate that are located on the positive and negative sides in the z-axis direction, as shown in FIG. 6. On the other hand, in the case of the laminated inductor 10, the insulator layer 20f is thinner than each of the inductive conductor layers 30a and 30b. Thus, the magnetic field lines H generated around the inductive conductor layers 30a and 30b do not become dense near both of the end surfaces of the laminate 12 that are located on the positive and negative sides in the z-axis direction, as shown in FIG. 3, so that reduction in the inductance value can be inhibited.

Incidentally, since the insulator layer 20f is thinner than each of the inductive conductor layers 30a and 30b, it is more readily possible for the combined cross-sectional shape of the inductive conductor layers 30a and 30b to constitute an ellipse as a whole. Specifically, the laminated inductor 10 is produced such that the inductive conductor layers 30a and 30b are opposed to each other with respect to the ceramic green sheet that is to act as the insulator layer 20f, which is thinner than each of the inductive conductor layers 30a and 30b. Here, the extent of the insulator layer 20f being compressed by pressure treatment in the pressure-bonding of the ceramic green sheets is determined by the thickness of the insulator layer 20f. In addition, the insulator layer 20f is thinner than each of the inductive conductor layers 30a and 30b. Accordingly, the extent of the insulator layer 20f being compressed is insignificant compared to the thickness of each of the inductive conductor layers 30a and 30b. Therefore, the insulator layer 20f is scarcely compressed by pressure treatment, so that the inductive conductor layer 30a is pushed to the negative side in the z-axis direction, and the inductive conductor layer 30b is pushed to the positive side in the z-axis direction. As a result, the cross section of the inductive conductor layer 30a has a semi-elliptical shape that bulges toward the negative side in the z-axis direction, and the cross section of the inductive conductor layer 30b has a semi-elliptical shape that bulges toward the positive side in the z-axis direction. That is, the combined cross-sectional shape of the inductive conductor layers 30a and 30b constitutes an ellipse as a whole. Thus, the fact that the insulator layer 20f is thinner than each of the inductive conductor layers 30a and 30b makes it easy for the combined cross-sectional shape of the inductive conductor layers 30a and 30b to constitute an ellipse as a whole.

Furthermore, in the laminated inductor 10, the insulator layer 20f (predetermined insulator layer) is positioned between the inductive conductor layers 30a and 30b. In addition, the insulator layer 20f is made of a non-magnetic material, and therefore, has a lower magnetic permeability than the insulator layers 20a to 20e and 20g to 20k, which are made of a magnetic material. Therefore, the magnetic field lines H generated when a current flows through the inductive conductor layers 30a and 30b are distributed across the laminate 12 along the y-axis direction, as shown in FIG. 3. That is, by interposing the non-magnetic layer between the inductive conductor layers, the path for magnetic field lines, which is a closed magnetic circuit, is turned into an open magnetic circuit. Accordingly, the laminated inductor 10 is less susceptible to magnetic saturation compared to the case where the insulator layer 20f has the same magnetic permeability as the insulator layers 20a to 20e and 20g to 20k. Thus, the laminated inductor 10 renders it possible to more effectively inhibit reduction in the inductance value due to magnetic saturation.

In addition, the laminated inductor 10 can be inhibited from being cracked by concentration of stress. Specifically, since the combined cross-sectional shape of the inductive conductor layers 30a and 30b constitute an ellipse as a whole, the number of corners in the cross-sectional shape of each of the inductive conductor layers 30a and 30b is less than the number of corners in the cross-sectional shape of each of the internal electrodes 508a to 508e in the electronic component 500. Therefore, the laminated inductor 10 has fewer areas where stress concentrates than the electronic component 500. Thus, the laminated inductor 10 can be inhibited from being cracked by concentration of stress.

Furthermore, the inductive conductor layers 30a and 30b of the laminated inductor 10 are formed by applying a paste of conductive material onto the insulator layers 20f and 20e. Accordingly, the laminated inductor 10 subjected to sintering can be more resistant to breakage and cracking compared to the case where the inductive conductor layers 30a and, 30b are formed by linear materials such as wires. Specifically, in the case where the inductive conductor layers 30a and 30b are formed by linear materials, such linear materials do not contain any binders or suchlike. Therefore, in the case where the inductive conductor layers 30a and 30b are formed by linear materials, when the laminate 12 is subjected to debinding and sintering, the inductive conductor layers 30a and 30b do not contract, but only the insulator layers 20a to 20k contract. Accordingly, stress is generated within the laminate 12 due to the difference in the ratio of contraction between the inductive conductor layers 30a and 30b and the insulator layers 20a to 20k. As a result, the laminated inductor 10 breaks and/or cracks. On the other hand, in the case where the inductive conductor layers 30a and 30b are formed by application of a paste of conductive material, the inductive conductor layers 30a and 30b are in paste form containing a binder or suchlike before the laminate 12 is subjected to debinding and sintering. Accordingly, when the laminate 12 is subjected to debinding and sintering, the inductive conductor layers 30a and 30b contract along with the insulator layers 20a to 20k. Therefore, stress is inhibited from being generated due to the difference in the ratio of contraction between the inductive conductor layers 30a and 30b and the insulator layers 20a to 20k. Thus, because the inductive conductor layers 30a and 30b are formed by application of a paste of conductive material, the laminated inductor 10 can be inhibited from being chipped and cracked after sintering.

### Experimentation

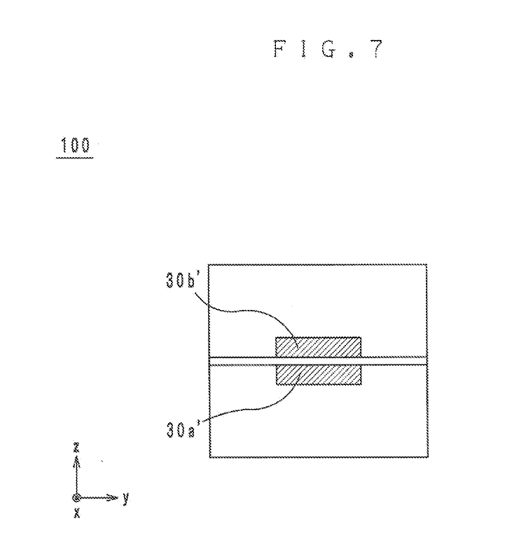

To clarify the effects achieved by the laminated inductor 10, the present inventors carried out experimentation through simulations. More specifically, a laminated inductor 10 was produced as a first sample. In addition, a laminated inductor 100 was produced as a second sample, where the laminated inductor 100 included inductive conductor layers 30a′ and 30b′ having rectangular cross-sectional shapes as shown in FIG. 7, unlike the inductive conductor layers 30a and 30b of the laminated inductor 10. Note that the size of each sample was 3.2 mm×2.5 mm×2.0 mm. Moreover, the width of each conductor layer was 640 μm in both of the first and second samples. However, each conductor layer was made to be 93 μm thick in the first sample, and also 73 μm thick in the second sample, so that the conductor layers of the first sample and the conductor layers of the second sample were equal in cross-sectional area.

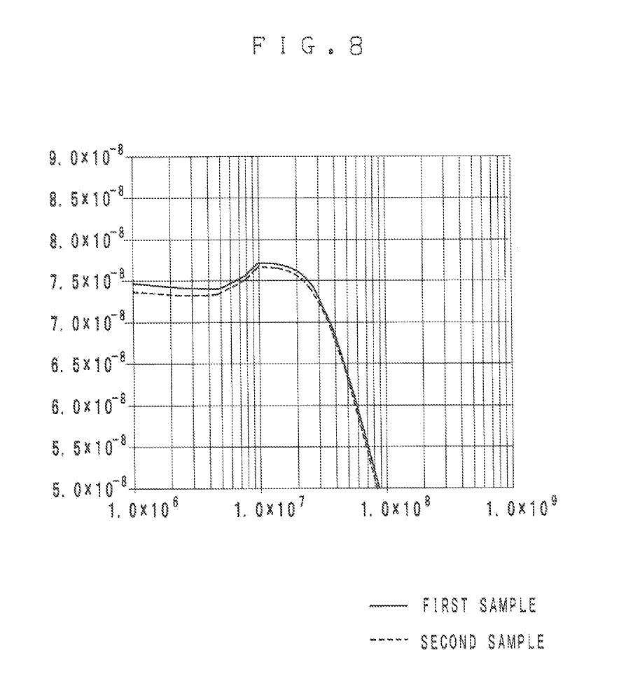

In experimentation, a current was applied to each of the first and second samples to measure frequency characteristics of the inductance value for each sample. FIG. 8 is a graph showing the results of a first experiment for the first and second samples. In FIG. 8, the vertical axis represents the inductance value (H), and the horizontal axis represents the frequency (Hz).

It can be appreciated from experimentation that the inductance value is higher for the first sample than for the second sample, as shown in FIG. 8. This indicates that magnetic saturation was inhibited by the combined cross-sectional shape of the inductive conductor layers 30a and 30b being elliptical, so that the inductance value was inhibited from being reduced.

### Other Examples

Note that the inductor according to the present invention is not limited to the above examples, and various changes can be made within the spirit and scope of the invention. Specifically, the material, shape, and size of each insulator layer can be selected appropriately in accordance with use. Moreover, the material, shape, and size of each inductive conductor layer can also be selected appropriately in accordance with use without departing from the spirit and scope of the invention. For example, the number of inductive conductor layers is not limited to two, and it may be three or more.

Furthermore, in the aforementioned examples, the inductive conductor layers 30a and 30b are in a linear shape, but they may be in, for example, meandering forms.

Although the present invention has been described in connection with the preferred embodiment above, it is to be noted that various changes and modifications are possible to those who are skilled in the art. Such changes and modifications are to be understood as being within the scope of the invention.

What is claimed is:

1. A laminated inductor comprising:
a laminate formed by laminating a plurality of insulator layers; and
a plurality of inductive conductor layers provided in the laminate and connected in parallel, wherein,
in a cross section perpendicular to a direction in which a current passes through the inductive conductor layers, a combined cross-sectional shape of the inductive conductor layers constitutes an ellipse as a whole.

2. The laminated inductor according to claim 1, wherein,
a predetermined insulator layer is provided between the inductive conductor layers, and
the predetermined insulator layer has a lower magnetic permeability than the insulator layers other than the predetermined insulator layer.

3. The laminated inductor according to claim 1, wherein,
a predetermined insulator layer is provided between the inductive conductor layers; and
the predetermined insulator layer is thinner than each of the inductive conductor layers.

4. The laminated inductor according to claim 1, wherein there are two inductive conductor layers.
